(19) United States
(12) Patent Application Publication
(10) Pub. No.: US 2003/0069953 A1
(43) Pub. Date: Apr. 10, 2003

(54) Modular server architecture with high-availability management capability

(76) Inventors: David A. Bottom, Arroyo Grande, CA (US); Jason Varley, San Luis Obispo, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/966,830

(22) Filed: Sep. 28, 2001

(51) Int. Cl. G06F 15/173

(52) U.S. Cl. 709/223

(57) ABSTRACT

A system, apparatus, and method are provided for nonstop management of a modular server architecture to achieve high-availability. According to one embodiment of the present invention, a server in the chassis is automatically elected as a managing server or active server to host system management. The active server runs service for all servers operating in the chassis. Upon failure of the managing server, such as when not meeting a certain predetermined criteria, another server is reelected as active server to replace the previous active server to continue with the nonstop management of the chassis and remaining servers.

### COPYRIGHT NOTICE

Contained herein is material that is subject to copyright protection. The copyright owner has no objection to the facsimile reproduction of the patent disclosure by any person, as it appears in the Patent and Trademark Office patent files or records, but otherwise reserves all rights to the copyright whatsoever.

### FIELD OF THE INVENTION

This invention relates to server architecture, in general, and more specifically to providing high-availability management in modular server architecture.

### BACKGROUND OF THE INVENTION

The idea of providing high-availability or fault-tolerance is nothing new. Many attempts have been made to provide a system with the ability to continue operating in the presence of a hardware failure. Typically, a fault-tolerant system is designed by including redundant critical components in a system, such as CPUs, disks, memories. In the event one component fails, the backup component takes over to immediately recover from the failure. Such fault-tolerant systems are very expensive and inefficient, because too much redundant hardware is wasted in the absence of failure.

Further, in today's fault-tolerant or high-availability system, the reason for hardware failure is generally unknown. This requires for an individual to physically visit the failed hardware in order to determine the reason(s) for failure, making maintenance an extremely expensive and time-consuming task.

Moreover, in today's Internet age, where almost everyone has had an experience with a variety of Internet applications, controlling and selling the Internet bandwidth to optimize performance, efficiency, and profitability is essential. Servers are at the heart of any network infrastructure because they are the engines that drive Internet Protocol (IP) services, and it is the builders of such infrastructures who control the growth of the Internet. Therefore, it is extremely important that those who build and operate data centers that interface with the Internet should strive to provide a secure, efficient, and reliable management environment in which to host IP services.

The methods and apparatus available today do not provide the ability to deploy instantaneously, simultaneously, and automatically any number of servers based on established business and technical criteria or rules, with high-availability, without user or operator intervention. Today's methods and apparatus are expensive because of the cost associated with necessary time, people, and floor space, inefficient, because they rely on user or operator intervention.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1A is a block diagram conceptually illustrating an overview of a high-availability (HA) management system, according to one embodiment of the present invention;

FIG. 1B is a block diagram conceptually illustrating a development server platform, according to one embodiment of the present invention;

FIG. 1C is a block diagram conceptually illustrating a deployment server platform, according to one embodiment of the present invention;

FIG. 2 is a block diagram of a typical management system computer upon which one embodiment of the present invention may be implemented;

FIG. 3 is a block diagram conceptually illustrating a server management system with an active manager, according to one embodiment of the present invention;

FIG. 4 is flow diagram conceptually illustrating an election process within a high-availability (HA) management system, according to one embodiment of the present invention;

FIG. 5 is a block diagram conceptually illustrating high-availability (HA) management, according to one embodiment of the present invention;

FIG. 6 is block diagram conceptually illustrating a network comprising a plurality of nodes having a modular server architecture, according to one embodiment of the present invention;

FIG. 7 is a block diagram conceptually illustrating uninterrupted management using sticky IDs, according to one embodiment of the present invention; and

FIG. 8 is a flow diagram conceptually illustrating the process of uninterrupted management using sticky IDs, according to one embodiment of the present invention.

### DETAILED DESCRIPTION

A method and apparatus are described for managing a modular server architecture for high-availability. Broadly stated, embodiments of the present invention allow automatic election and reelection of a server in the chassis as a managing server or active server to host system management.

A system, apparatus, and method are provided for management of a modular server architecture to achieve high-availability. According to one embodiment of the present invention, a server in the chassis is automatically elected as a managing server or active server to host system management. The active server runs service for all servers operating in the chassis. Upon failure of the managing server, such as when not meeting a certain predetermined criteria, another server is elected as active server to replace the previous active server to continue with the management of the chassis and remaining servers.

According to one embodiment, health and performance monitoring is performed by extracting each server module's health and performance metrics, which are stored in a local database. Such health and performance metrics are made available for various applications, such as a graphical user interface (GUI) and a web-server interface.

According to another embodiment, servers in the chassis host a web server that uses an in-memory database with configurable replication members of the management cluster. A communication and replication of the definable health and performance metrics stored in an individual server's database is provided to any or all other server modules, and its own information is communicated to any or all other servers in the chassis.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

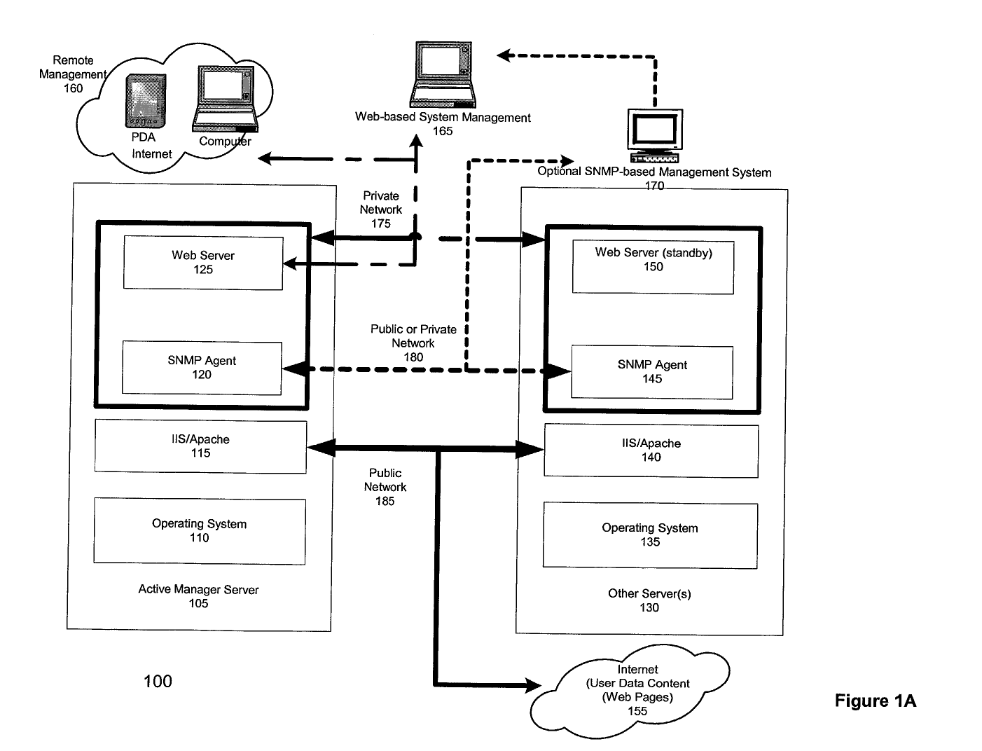

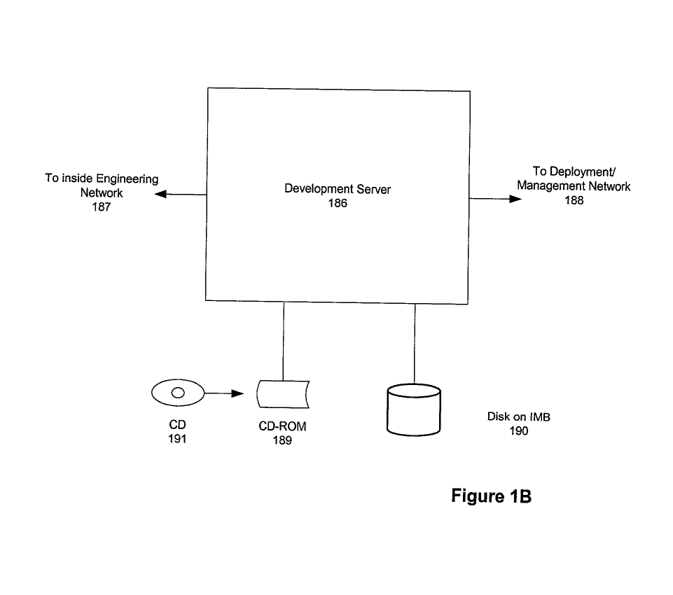

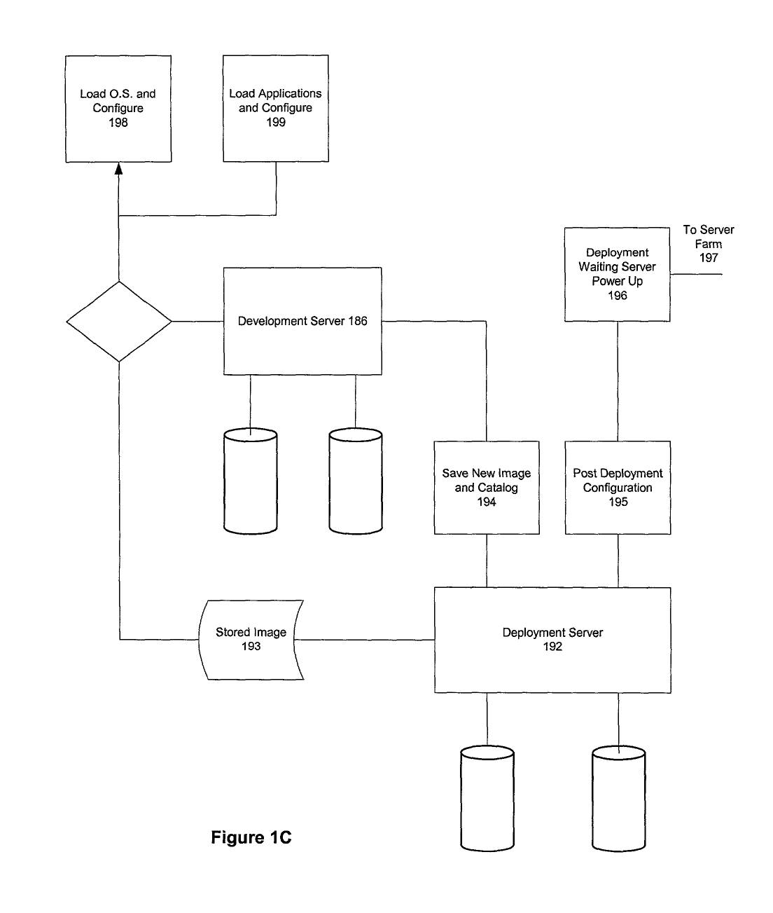

FIG. 1A is a block diagram conceptually illustrating an overview of a high-availability (HA) management system, according to one embodiment of the present invention. Huge growth in Internet usage demands instant deployment and scalability. The first item to address in an infrastructure to enable a revolutionary provisioning solution is the server platform itself, and the most critical of all needs is reliability. Without reliability other business efforts would be in vein. Reliability may demand telecom-grade or carrier-class server hardware constructed with the capability to perform hot-swap of modular system components and with robust and feature-rich health and performance monitoring. In such as solution, server “blades” can be exchanged when service is needed or upgraded to new server blades without loss of Internet functionality.

The HA management system 100 may be employed to address, but is not limited to, the exponential demand for carrier-class reliability in a high density communications environment, offering instant deployment and comprehensive management of servers 130 in an Internet data center. When more server capacity is needed, operations managers or account executives can remotely and automatically deploy more servers quickly and easily, or allow other applications (such as clustering) to automatically trigger deployment of more servers when capacity reaches a threshold. Further, the HA management system 100 may drastically reduce real estate costs, allow for rapid scaling when more capacity is required, and data centers may maximize server capacity. The Hot-add/hot-swap modular architecture may allow for 5-minute MTTR and scaling.

According to one embodiment, comprehensive manageability, according to one embodiment, may provide remote monitoring via a web-based interface for NOC operations and customers, ensure high availability, and allow easy tracking of failed device and 5-minute MTTR. Further, comprehensive manageability may comprise multi-level management with web-based 125, 150, highly integrated, system management software, standards-based SNMP Agent 120, 145 to integrate with existing SNMP-based systems 170, and local management via LCD-based console on server enclosures.

According to one embodiment, the HA management system 100 system management delivers to the Internet data center a comprehensive, disciplined means for system administration, system health monitoring, and system performance monitoring. Since the server's health and performance metrics may be used to initiate automated deployment processes, the source of those metrics would have to be reliable. The metrics used to initiate the automated processes might include CPU, physical or virtual memory, disk and network IO or storage capacity utilization. Additionally a failure alert or cluster load alert responding to prescribed SLAs (Service Level Agreement) might initiate an automated deployment process. Therefore, the reliability afforded by High-Availability management (HA management) is instrumental in enabling robust automation capacity.

The HA management of the present invention is highly reliable. Advantageously, the HA management system 100 is fault tolerant, which leverages the carrier-class modular architecture of a server system, and does not requires costly management module. The HA management system 100 may provide health and performance detection system, and system administration, with failure detection/recovery with auto alerts and logs. Further, the HA management system 100 may manage remotely from a Network Operations Center 160 or over the Internet using a web-based 165 highly integrated manager. The HA management system 100 may be fault-tolerant with fail-over protection, so that the system 100 or user-defined auto-alerts may predict failures before they happen and track system and network performance for capacity planning, with no additional requirement for hardware.

According to one embodiment, a server 130 may be booted from the network even when it has a new, unformatted disk drive. If the server 130 can be booted from the network, then there may be not need for hardware configuration or software installation prior to bolting the gear into the racks of the data center. Further, the new server 130 may be unpacked and installed in the Internet data center and powered up so that Engineering or the NOC can remotely initiate deployment. Similarly, a “headless” operation of servers 130 may be expected—in other words, an operation without a keyboard, mouse, or monitor. Further, all the operation of the servers 130, including power up, may be controlled remotely.

According to one embodiment, an active manager 105 may provide single-point access into a group of servers 130 for a comprehensive system management. For example, the access may be provided via a web-based user interface 175 that provides full monitoring, configuration, and failure detection/recovery of all servers 105, 130 in any given group. Further, from the interface, a user may monitor pertinent system status, performance status, and environmental parameters that can be used to identify a chassis or server that is malfunctioning, incorrectly configured, or is at risk of failing. According to one embodiment, the information may be displayed in a hierarchical fashion to provide a quick, easy, and efficient way to take a detailed look at any of the server components. Further, the centralized alert mechanism may be employed to provide a clear indication of new warning or critical conditions, even while displaying information about other system components.

According to one embodiment, a server 105 may be automatically elected as an active manager server 105 to host system management. At least two or more servers 105, 130 in the chassis may be required to run an HA system management. The active manager 105 may run as a service to all operating servers. By way of an example, according to one embodiment, the active manager server 105 may run on less than 1% CPU utilization, allowing the active manager server 105 to also run other applications. The server 105, 130 in the chassis may host a special, small-footprint web server using an in-memory database with configurable replication among members of the management cluster. In the event of a failure of the active manager server 105, another server 130 may automatically be elected as the active manager server, providing continuous management of the chassis and remaining servers.

According to one embodiment, the web-based interface 175 may provide access at any time, from any location. It may provide a single-point of access, where requests may automatically be sent to any of the servers 105, 130 within the group, and such requests may be redirected to the new active manager server if the previous active manager server is known to be replaced by the new active manager server. The dynamic content for constant monitoring may be performed through the use of Java, JavaScript, and ASP technology.

According to one embodiment, the HA management system 100 may comprise an in-memory database for fast access to stored data. Further, the HA management system 100 may provide for the users to define low and high-alert thresholds and propagation of health and performance alerts, and the users may also define the intervals at which the system performance and utilization metrics are computed. The middleware may automatically be notified every time a threshold boundary (e.g., temperature level) is crossed. According to one embodiment, the HA management system 100 may also include an SNMP agent 120, 145 for private LAN management networks. Plug-ins may become available for, for example, HP's Open View, and possibly other SNMP-capable mangers such as CA's UniCenter and IBM's Tivoli. According to one embodiment, modular hot-add/hot-swap components may include server blade with CPU and memory, media blades with HDDs, and switch blades with 20-port Ethernet.

Typically, a server platform will need to provide means to identify itself as a unique server among all others on the network. The MAC address of the Ethernet adapter might be one way; however, with typical servers 105, 130 the adapter may be changed or replaced, so a more reliable solution may be required. An alternative solution may be to have a unique serial number recorded in non-volatile memory on the server blade that can be read across the network to positively identify the server 105, 130.

According to one embodiment, each server 105, 130 may have at least two network interfaces to optimize performance. One interface may be connected to an Ethernet switch whose uplink may be routed to the Internet, while the second network interface may be connected to another switch whose uplink may be connected to an “inside” deployment/management network.

Typically, when individual servers are deployed in a data center, their location uniqueness cannot be determined in a static, dormant, or powered, but non-operational, non-operational, state. When a server module is replaced, it cannot be immediately identified to the management or provisioning software system(s) in terms of its type, location, and function, even if it can be uniquely identified. This is particularly true when the management is remote or processes are to be automated. According to one embodiment, in a modular server architecture, a unique location of a server module to be managed or provisioned may be identified while still maintaining the original server module's own unique identification. This may allow a failed server module to be replaced and still be managed and provisioned as the original server module.

Any manufacturer of equipment providing management capability that can be operated or managed remotely or that requires automation or processes may be interested in using the positive location identification capability of the present invention. Further, companies using electronically readable unique chassis identification and referenced physical server module slot location to determine server module location for management and provisioning may be interested various embodiments of the present invention.

FIG. 1B is a block diagram conceptually illustrating a development server platform, according to one embodiment of the present invention. According to one embodiment, the infrastructure may require a dedicated development server 186 to facilitate installation and configuration of operating system, services, and applications on its production servers. A development server platform may be constructed with hardware identical to servers on the production data center floor so that device drivers and system configuration will match. These servers may differ from production servers only in that they may require the addition of a CD-ROM drive 189 for operating system and application software installation. In this way, the server operating system, operating systems services, and application software may be installed, configured, and tuned to meet a particular customer's needs. Further, no floppy drive may be required; however, the CD-ROM drive 189 may need to support boot of the operating system's CD 191. Each development server (blade) 186 may support a keyboard, mouse, and video display.

The development server chassis 186 may be located in a data center's engineering department or in the NOC. For example, one Ethernet network interface of the development server 186 may be connected to the deployment/management network 188, and another may be hooked to an internal engineering network 187 or inter-data center network.

FIG. 1C is a block diagram conceptually illustrating a deployment server platform, according to one embodiment of the present invention. For a robust, reliable, and highly automated infrastructure, a dedicated deployment server 192 may be required, along with a development server 186. The deployment server 192 may be identical to the development server 186 with the addition of deployment software and a web-based management interface. The deployment server 192 may be as reliable as any other server 105, 130 in the data center, especially if automated deployment processes for recovery or scaling are to be mandated to meet SLAs. Further, server system health monitoring may be critical to ensure that automated or scheduled processes do take place. Therefore, the deployment server 192 may need to be constructed with the same care and features as the productions server being used.

According to one embodiment, for convenience, the deployment server 192 may be rack-mounted in the data center. If simultaneous multi-server deployment is to be carried out on different subnets, then a deployment server 192 may need to be installed for each of the subnets. A deployment server 192 for specific customers may also be installed in each of the customers' own restricted access area if so desired. Further, a server image 193, if created, may be deployed to servers in multiple data center sites, which may mean that deployment servers 192 would have to be located in each of those other data centers. All of the deployment servers 192 may then be connected on a private network among all data centers. Each of the deployment servers 192 may gather the image(s) 193 from the same deployment server 192. Each of the deployment servers192 located in the data center maybe connected to an inside management and deployment network from one of the two Ethernet network ports envisioned in the ideal platform. The other Ethernet network port may be used to connect the inter-data center network used for multi-site deployments.

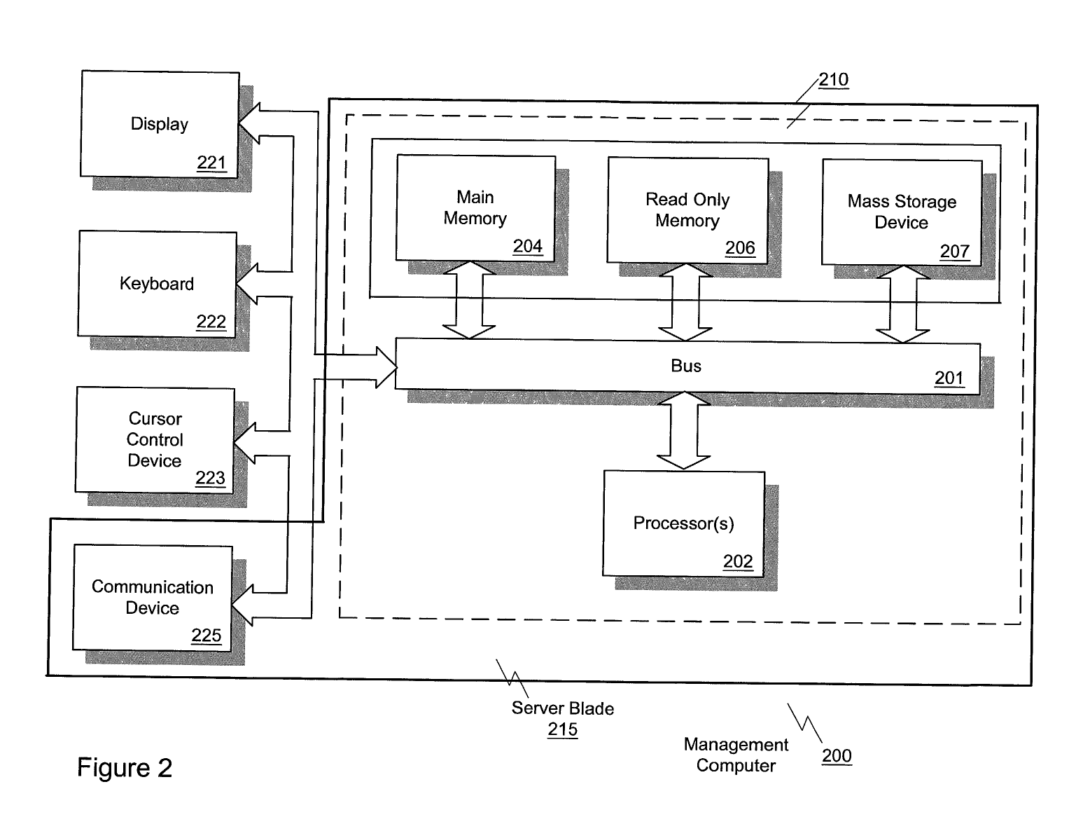

FIG. 2 is a block diagram of a typical management system computer (management computer) upon which one embodiment of the present invention may be implemented. A management computer 200 comprises a bus or other communication means 201 for communicating information, and a processing means such as processor 202 coupled with bus 201 for processing information. The management computer 200 further comprises a random access memory (RAM) or other dynamic storage device 204 (referred to as main memory), coupled to bus 201 for storing information and instructions to be executed by processor 202. Main memory 204 also may be used for storing temporary variables or other intermediate information during execution of instructions by processor 202. The management computer 200 also comprises a read only memory (ROM) 206 and/or other static storage device 206 coupled to bus 201 for storing static information and instructions for processor 202. The combination of the main memory 204, ROM 206, mass storage device 207, bus 201, processor(s) 202, and communication device 225 serves as a server blade 215.

A data storage device 207 such as a magnetic disk or optical disc and its corresponding drive may also be coupled to computer system 200 for storing information and instructions. The management computer 200 can also be coupled via bus 201 to a display device 221, such as a cathode ray tube (CRT) or Liquid Crystal Display (LCD), for displaying information to an end user. Typically, an alphanumeric input device 222, including alphanumeric and other keys, may be coupled to bus 201 for communicating information and/or command selections to processor 202. Another type of user input device is cursor control 223, such as a mouse, a trackball, or cursor direction keys for communicating direction information and command selections to processor 202 and for controlling cursor movement on display 221.

A communication device 225 is also coupled to bus 201. The communication device 225 may include a modem, a network interface card, or other well-known interface devices, such as those used for coupling to Ethernet, token ring, or other types of physical attachment for purposes of providing a communication link to support a local or wide area network, for example. In this manner, the management computer 200 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of the management computer 200 will vary from implementation to implementation depending upon numerous factors, such as price constraints, performance requirements, technological improvements, and/or other circumstances.

It should be noted that, while the steps described herein may be performed under the control of a programmed processor, such as processor(s) 202, in alternative embodiments, the steps may be fully or partially implemented by any programmable or hard-coded logic, such as Field Programmable Gate Arrays (FPGAs), TTL logic, or Application Specific Integrated Circuits (ASICs), for example. Additionally, the method of the present invention may be performed by any combination of programmed general-purpose computer components and/or custom hardware components. Therefore, nothing disclosed herein should be construed as limiting the present invention to a particular embodiment wherein the recited steps are performed by a specific combination of hardware components.

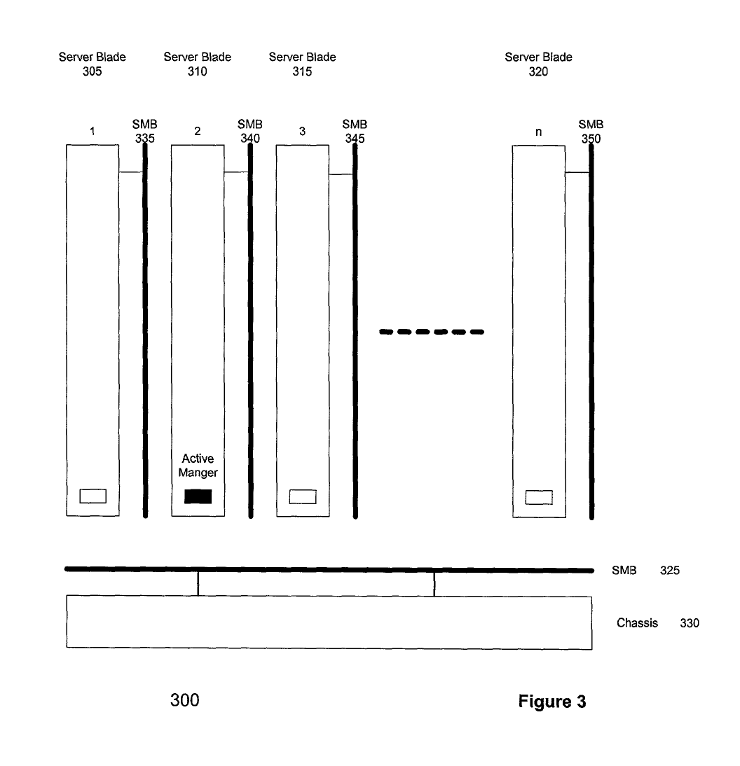

FIG. 3 is a block diagram conceptually illustrating a server management system with an active manager, according to one embodiment of the present invention. According to one embodiment of the present invention, a High-Availability System Manager (HA Manager) may be installed on each of the server blades 305-320 in a chassis 330. When server health and performance metrics are to be used to initiate automated processes, the source of those metrics would have to be reliable. The High-Availability management (HA management) of the present invention is highly reliable. There may be at least two server blades installed in the chassis 330 to perform HA management. According to one embodiment, an election process may decide which one of the server blades 305-330 is to be the active manager of the chassis 330. The election may be performed based on various factors, which may be predetermined. For example, it may be predetermined that a server blade, e.g., 310, with the lowest IP address will be chosen as the active manager. Once elected, the active manager 310 performs its duties until it fails or shuts down for some reason, such as an upgrade. In any event, when the active manager 310 fails, or is to be replaced, another election process takes place to elect the next active manager. For example, the server blade with the lowest IP address at the time may be elected as the new active manager. The election of the next active manager may occur almost immediately. Further, according to one embodiment, a redirection process may simply redirect anyone contacting the failed (previously active) manager to the new manager.

According to one embodiment, a System Management Bus (SMB) 335-350 may be present on each of the server blades 305-320, and an SMB 325 on the chassis 330 midplane board. The active manager 310 may communicate with the midplane SMB 325 to monitor the chassis 330 as well as each of the remaining server blade SMBs 335-350. The server blade SMBs 335-350 may communicate with on-board devices for health and performance monitoring. Such health and performance metrics may then be used to continuously manage the system.

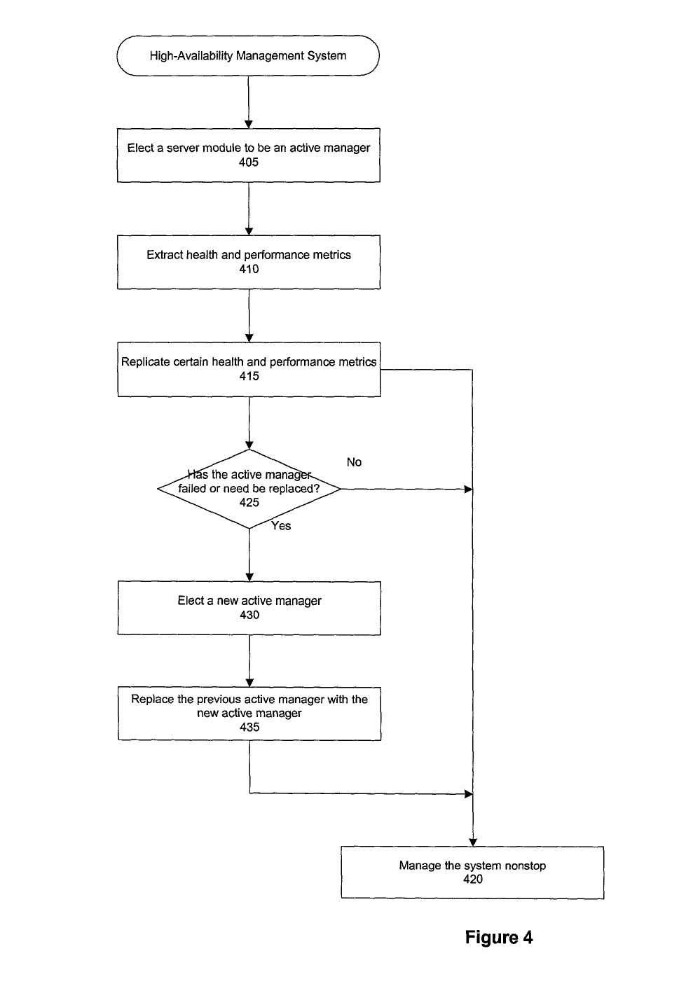

FIG. 4 is flow diagram conceptually illustrating an election process within a high-availability (HA) management system, according to one embodiment of the present invention. First, an election process may elect one of the server modules (modules) to be an active manager of the chassis in processing block 405. The election of the active manager may be based on certain predetermine criteria or factors, such as a module having the lowest IP address. The active manager may extract health and/or performance metrics relating to the chassis and to any or all of the modules in the chassis in processing block 410. The active manager may control and monitor the chassis and devices, which report the health and performance of the system chassis. Health metrics may include information regarding power, and temperature of the devices, while the performance metrics may include information regarding CPU and memory utilization. According to one embodiment, certain health and performance metrics may be replicated to all other modules in the chassis in processing block 415. The active manager may report replicated information relating to a failed device so that the failed device may efficiently be replaced with a new device. The active manager may continue to manage without any reconfiguration or update despite switching the failed device to the new device in processing block 420.

Similarly, the management determines whether the active manager has failed or needs to be replaced in decision block 425. While the active manager is performing according to the predetermined criteria or factors, the management may continue nonstop management in processing block 420. However, in the event the active manager fails, a re-election process may take place to elect a next active manager in processing block 430. The re-election process may be performed based on the same predetermined factors/criteria as applied in the initial election process. Further, the management may utilize the replicated information relating to the failed active manager to perform an effective, efficient, and nonstop reelection of the new active manager. The new active manager may takeover the duties of the failed active manager without the need for a reconfiguration or updated in processing block 435. The new active management continues the duties of the active management without much interruption in processing block 420. According to one embodiment, the redirection mechanism may redirect any new application accessing the failed active manager to the new active manager. The redirection process may be accomplished in various ways including, but not limited to, the same way a web browser is redirected to a new website when accessing the old website that is no longer active.

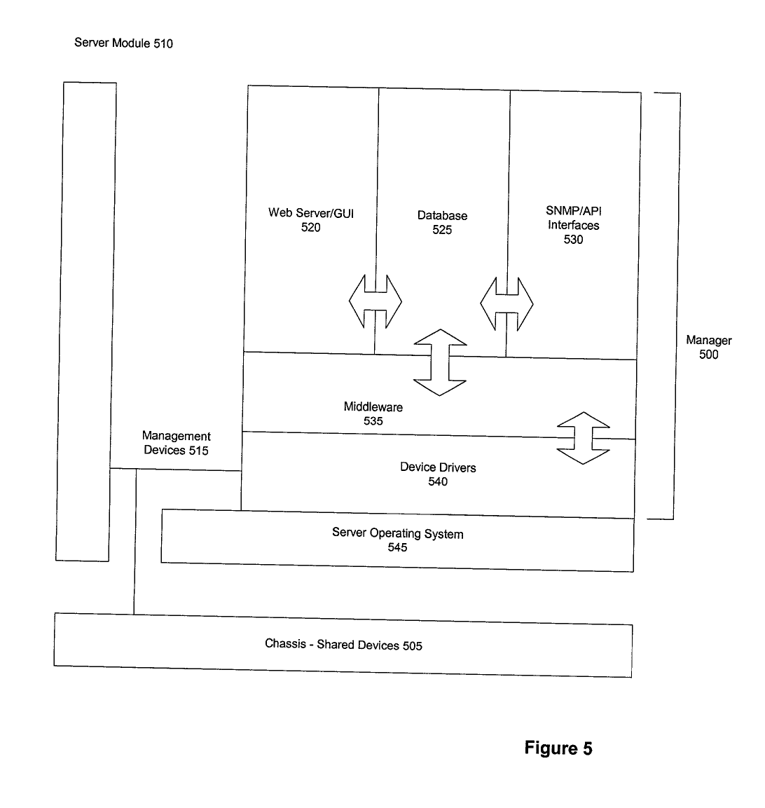

FIG. 5 is a block diagram conceptually illustrating high-availability (HA) management, according to one embodiment of the present invention. As illustrated, a server module (module) 510 may be coupled to hardware device drivers 540, runs applications or services, which via hardware device drivers 540 communicate with server devices and server operating system (operating system) 545. According to one embodiment, each server module 510 may have a separate server management device (management device) 515, such as a hardware device requiring a device driver in order for the operating system 545 to communicate with the management device 515 and the software middleware (middleware) 535. The management device may include, but are not limited to, temperature sensors, voltage sensors, and cooling fan tachometer sensors. The device drivers 540 may control the management devices 515, which manage and monitor various factors, such as temperature, including board temperature, processor temperature, etc. These management devices 515 may be appropriately developed for each server operating system 545 to provide the same information regardless of which operating system they are developed for.

The high-availability may be determined either by the ability to function (health) and provide service, or to perform at a level that can maintain services (performance). Each server module or blade 510 may run an application or service, which via hardware device driver may communicate with the management device 515 and the operating system 545 to report health and performance metrics on each of the modules 510. According to another embodiment, the middleware 535 may communicate directly with the operating system 545 and derive performance metrics and health metrics. In terms of high-availability, the health metrics and performance metrics may be synonymous. The shared devices 505 on chassis may provide information regarding speed, temperature, power supply, etc. For example, temperature sensors in the chassis may measure the temperature in various areas of the chassis; the power supply sensor may provide information regarding whether the power is functioning normally, or whether any of the power supplies have failed.

According to one embodiment, the module 510 may run an application, which may access the lower level device drivers 540 to extract information, such as health and performance metrics, about devices in the chassis, and maintains communication with the operating system 545. The middleware 535 may provide these metrics to be stored in a local database 525, and at the same time may make the database of metrics available to higher level applications including graphical user interface (GUI) and web-server interface 520, and may provide transport to industry standard management protocols, such as simple network management protocol (SNMP) 530, HP's Open View, IBM's Tivoli, and other SNMP-capable managers. The middleware 535 may further provide communication of and replication of definable health and performance metrics stored in an individual server's database 525 to any or all other server modules, and may communicate its own state information to any or all other servers in the chassis.

According to one embodiment, the information extracted by the middleware 535 may vary in nature, and therefore, may be extracted from the in memory database 525 only once or periodically or whenever necessary. Information that is static in nature, such as serial number of the device plugged in, chassis ID number of the chassis in which the device is plugged into, or slot ID number in the chassis in which the device is plugged into, may only be extracted from the in-memory database 525 once or whenever necessary, and saved for future reference. Dynamic information, such as temperature level, power level, or CPU utilization, on the other hand, may be extracted periodically or whenever necessary. The middleware 535 may store the information in a memory database 525, providing information to a web server 520 and, simultaneously or alternatively, to another side of interface, such as either through an application programming interface or custom-make it for existing customer software or to SNMP 530, where they may have an existing management infrastructure. Hence, one is to interface the existing customer management and the other is to have web server 520 that allows web access to the management.

According to one embodiment, the middleware 535 may extract information to determine if the devices are operating and performing properly, such as to know the current network utilization. With predetermined performance and health thresholds, the information extracted by the middleware 535 may help determine whether any of the thresholds are being violated. For example, in case of a violation, the reason for failure of a device may be known, and consequently, the device may immediately be replaced without any significant interruption. Similarly, if the active management itself fails or needs to be replaced for any reason, a new manager may be reelected to continue the nonstop high-availability management of the devices. Further, according to one embodiment, all the critical information may be replicated to keep the information constantly and readily available. The information may be classified as critical based on, but not limited to, prior experience, expert analysis, or predetermine criteria. The replication of information may be used to quickly and exactly determine which device had failed, and the status of the device shortly before it failed. Using such information, the device may be efficiently and immediately replace with no significant interruption. The information, particularly the critical information, about a failed device, such as a disk drive, is not lost with the failure of the device, and is therefore, readily available for use to continue the uninterrupted management.

By way of an example, table I illustrates health metrics, performance metrics, identification metrics, and the resulting data replication status. Table I is as follows:

TABLE I

| HEALTH | PERFORMANCE | IDENTIFICATION | DATABASE |
|---|---|---|---|
| METRICS | METRICS | METRICS | REPLICATION |
| | | Chassis ID | Static (Replication: |
| | | | Once) |
| Power Level | | | Dynamic |
| (Alert/Sensor-based) | | | (Replication: |
| | | | Periodically) |
| Temperature Level | | | Dynamic |
| (Alert/Sensor-based) | | | (Replication: |
| | | | Periodically) |
| | CPU Utilization | | Dynamic |
| | (Alert/O.S.-based) | | (Replication: |
| | | | Periodically) |
| | Memory | | Dynamic |
| | Utilization(Alert/O.S.- | | (Replication: |
| | based) | | Periodically) |

Table I is divided into the following four columns: Health, Performance, Identification, and Database Replication. Information included in the health column may be sensor-based, such as status of power supply and temperature. Information included in the performance column may primarily be operating system-based, such as the level of CPU and memory utilization; however, may also include sensor-based information. The identification column of table I may comprise identification-based user-defined information, such as location and chassis identification. The information contained in the identification column may primarily be static information. For example, even when a device is replaced with another device, it is considered a change in device rather than a change is status, leaving the identification information static.

Health-related information, on the other hand, according to one embodiment, is usually dynamic in nature. For example, availability of power, and fluctuations in temperature level are dynamic, because they may periodically change. The health-related information may also be alert-oriented. For example, if the temperature exceeds the level of temperature allowed to run off of an operating system environment, the system may trigger the alert mechanism. The information may be recorded in the database and be replicated. Consequently, in case of a device failure, the replicated information may provide the last status of the device shortly before it failed.

According to one embodiment, performance-related information may generally relate to how the system is working, and what generally are the instances of performance. For example, the performance-related information may include information about CPU utilization and memory utilization, as illustrated in table 1. Performance-related information may be sensor-based, as the health-related information, and may also be operating system-based and kernel-based. Specific devices may define utilization. Performance-related information may also trigger the alert mechanism. Additionally, performance-related information may also cause user-defined alert. For example, if disk utilization is an issue, a user-defined alert may trigger when running out of disk space or encountering a problem with the ability to read and write off of the disk.

According to one embodiment, the database may be continuously populated with the health, performance, and identification information. The information extracted may be replicated depending on various factors, such as how critical the information is, the nature of the information, and on whether the information is static or dynamic. For example, chassis identification or location identification may not be replicated. However, on the other hand, information such as slot identification, serial numbers, revision information, and manufacturer's model number may be replicated. Such information may help determine the last stage of the device immediately before the failure in case of a failure of the device.

For example, the disk and manufacturer model numbers of the device in the second slot of a chassis in a certain location may be stored in the database 525 and replicated, so that if and when the device fails, the replicated information would be available for the management to continue to manage the system nonstop. Further, static information may only be replicated once, while dynamic information may be replicated periodically or whenever necessary. According to one embodiment, the periodic replication of the dynamic information may provide a snap shot of the progression of the device over a certain period of time.

According to one embodiment, as discussed above, information based on certain factors may be chosen to be replicated, to avoid unnecessary traffic. The factors may be pre-determined and/or user-defined, and may include, for example, type and nature of the information. Primarily, information classified as critical for the HA management of the system may be replicated. Further, most of the dynamic information may be replicated periodically or whenever necessary, so that the database 525 stays updated. When replicating certain health and performance-related information the database 525 may be populated with alert triggers, so that the managing system is alerted every time certain thresholds are met and/or crossed.

According to one embodiment, the management system may use the unique sticky module location identification to precisely know the location of the server chassis (shelf or chassis ID) and the location of the server modules (slot ID) in the chassis of a failed module. Additionally, with the use of the replicated information, the management system may provide for the uninterrupted management of replacement modules serving the same purpose as the purpose served by the replaced module. This may eliminate the need for reconfiguration of the management, and intervention for performance of a maintenance task.

According to one embodiment, the server chassis may provide local management via a backlit Liquid Crystal Display console. A series of menu navigation button allows service personnel to read system-specific identification and configuration information and to view status of the system and each of its field-replaceable modules. The IP address of each server's Ethernet ports may be configured via the local console. This LCD console speeds routine maintenance tasks and minimizes operator errors that could cause unwanted distribution of service.

High-availability management may be critical in any equipment used for providing services in the Internet Data Center or next generation Packet Switched Telephony Network equipment. Due to full automation of provisioning and scaling of the systems, and to avoid risking their failure, the management would have to be highly reliable. The embodiments of the present invention may provide such reliable management at a low cost architecture to meet the HA management requirements, and be capable of supporting the HA management.

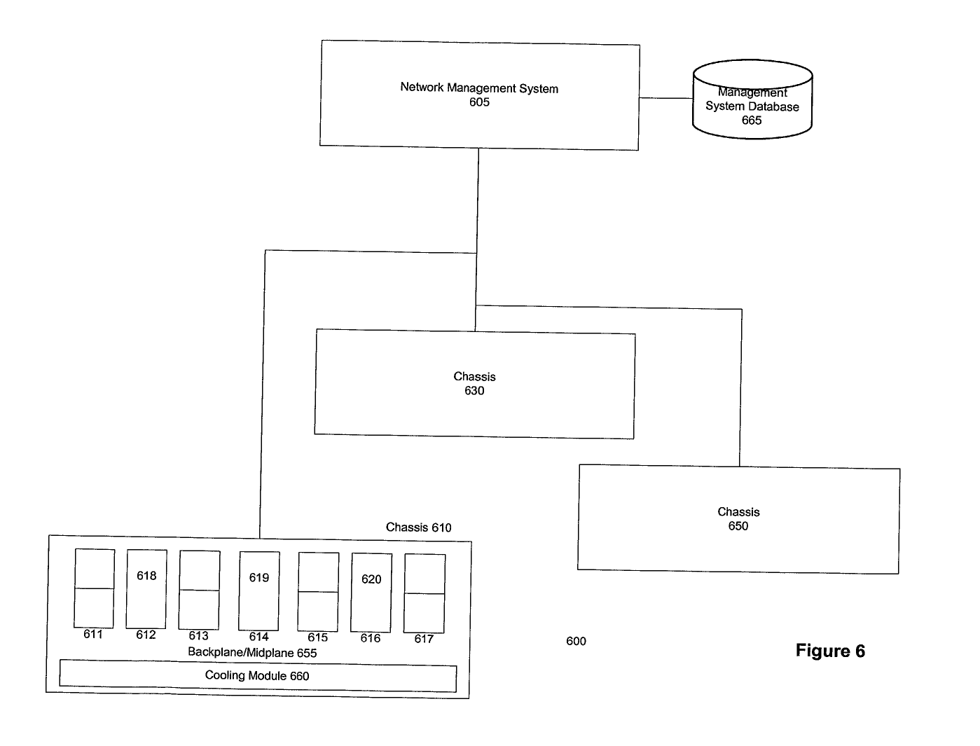

FIG. 6 is block diagram conceptually illustrating a network comprising a plurality of nodes (e.g., chassis 610, 630, 650) having a modular server architecture, according to one embodiment of the present invention. In this example, an Ethernet network 600 is used. Such a network may utilize Transmission Control Protocol/Internet Protocol (TCP/IP). Of course, many other types of networks and protocols are available and are commonly used. However, for illustrative purposes, Ethernet and TCP/IP will be referred to herein.

Connected to this network 600 are a network management system (management system) 605 and chassis 610, 630, 650. The management system 605 may include Internet-based remote management, Web-based management, or optional SNMP-based management. The chassis 610, 630, 650 may include a management server (active manager) and other server(s). The active server may provide a single-point access into a group of servers for comprehensive system management.

For illustration purposes, chassis 610, 630, 650 have identical architecture, and therefore, only chassis 610 is shown in detail and will be the focus of discussion and examples. Any statements made regarding chassis 610 may also apply to other chassis 630, 650 illustrated in FIG. 6. The management system 605 may include a management computer with a machine-readable medium. Various management devices, other than the management system 605 illustrated, may be used in the network 600.

The modular server architecture, e.g., as in chassis 610, may comprise a group of servers 618, 619, 620, where each server 618-620 may be a module of a single system chassis 610. According to one embodiment, each chassis 610 represents a multi-server enclosure and may contain slots 611-617 for server modules (modules) 618-620 and/or other field-replaceable units, such as Ethernet switch blades or media blades. The modules 618-620 may be separate servers in the network 600. The management system 605 may manage several modules through the slots in each chassis, such as managing modules 618-620 through slots 612, 614, 616, respectively, in chassis 610.

The management system 605 may need to know module characteristics of each module that is coupled with the management system 605. However, the management system 605 may also keep track of the “type” corresponding to each module 618-620 in each slot 611. According to one embodiment, chassis 610, 630, 650 may each be assigned a unique chassis identification, such as a number, by the management system 605. The unique chassis identification number may include information indicative of physical location, such as a shelf ID. The chassis ID may be coupled to each chassis 610, 630, 650 such as electronically readable to the management system 605.

Further, according to one embodiment, each slot 611-617 in chassis 610 may have a slot location, which may be used to assign slot identification to each of the slots. For example, the second slot 612 in chassis 610 may be assigned a unique slot identification number (slot ID number) 612.

According to one embodiment, the modules 618-620 coupled to the management system 605 may include any of several different types of devices, such as, but not limited to, servers, telephone line cards, and power substations. The management system 605 may assign a module type to each of the slots using their chassis identification and slot identification. For example, the second slot 610, with slot ID number 612, in chassis 610, may have a module type X assigned to it. The management system 605 may then manage any module 618 coupled to the second slot 612 of chassis 610 as a module of type X. The module type assigned may correspond to the module characteristics of the modules that will function in the specific slot in the specific chassis. According to one embodiment, the management system 605 may determine the module characteristics according to the module type assigned without the network operations having to stop so the management system 605 can be updated.

According to one embodiment, in order to manage a module 618-620, the management system 605 may also need to know module characteristics, such as, but not limited to, function and/or location of a module. Hence, according to one embodiment, module characteristics may comprise type, function, and location. Such module characteristics along with their associated chassis identifications, slot identifications, and relative module types may be stored in a management system database 665, or somewhere else, such as on a disk drive, coupled to the management system 605.

According to one embodiment, each chassis 610, 630, 650 and module 618-620 may also have user-defined identifications that may be kept in the management system database 665, or somewhere else, such as on a disk drive. These user-defined identifications may continue to be used even when the module 618-620 is replaced. Further, each module 618-620 may have a unique serial identification that may be electronically readable. The unique serial identification on the module 618-620 may be used for other independent purposes including, but not limited to, capital equipment management and fault tracking.

According to one embodiment, all modules 618-620 may communicate with any or all other modules 618-620 contained in a chassis 610 via a backplane or midplane 655, which may include routing of a network fabric, such as Ethernet, across the backplane or midplane 655, integrate a fabric switch module, which plugs into the backplane or midplane 655, control communication between the modules, and provide chassis identification, slot identification, and module type/identification.

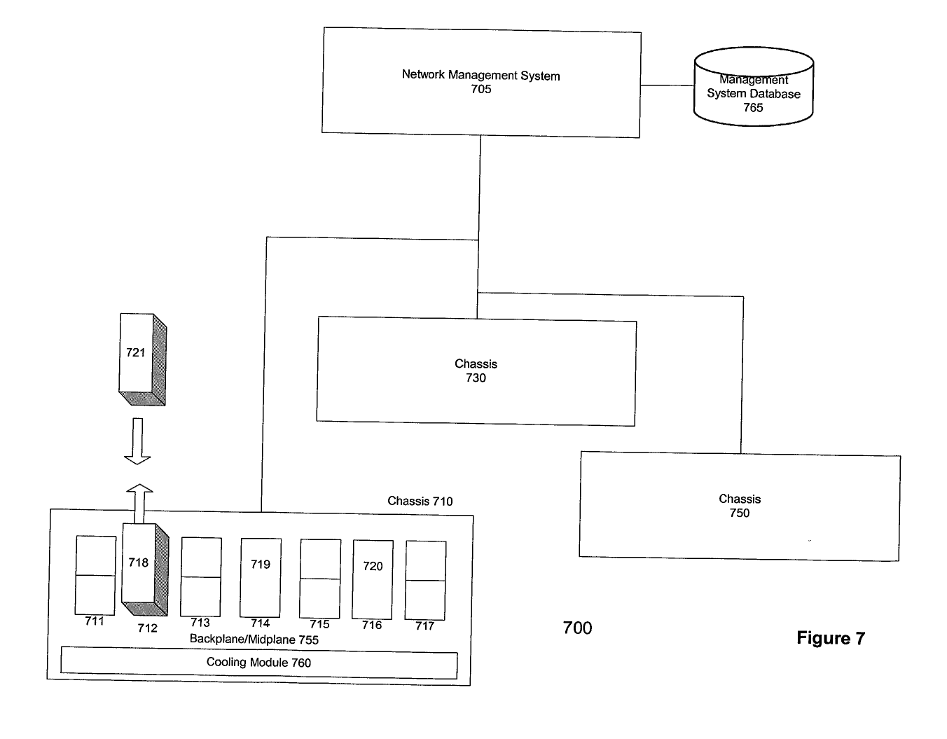

FIG. 7 is a block diagram conceptually illustrating uninterrupted management using sticky IDs, according to one embodiment of the present invention. According to one embodiment, when a first module 718 is replaced by a second module 721 in a slot 712, the network management system (management system) 705 may be able to determine the module characteristics of the second module 721 based to the module type assigned to the slot 712 and chassis 710 in which the slot 712 resides. In other words, because the module characteristics are known, the management system 705 may continue to operate without needing to be reconfigured by stopping and updating. Hence, providing uninterrupted management of the replacement module 721 serving the same purpose as the one replaced 712, unless specifically determined otherwise.

As illustrated, by way of example, the management system 705 manages chassis 710, 730, and 750. Chassis 710 may have a unique identification number, for example, 660007770088. Additionally, chassis 710 may have other information associated with it. For example, the management system 705 may assign chassis ID numbers starting with 6 as being assigned to all the chassis, e.g., 710, 730, 750, located in a certain part of the network 700 or with a certain function in the network 700. Sticky IDs may include system-defined unique identification numbers and/or user-defined unique identification numbers.

Chassis 710 may have a slot 712 with slot ID number 712. The management system 705 may be programmed to manage modules, e.g., 718, in slot 712 of the chassis 710 with the chassis ID number 660007770088 as module type X. Module type X may have module characteristics of a specific type, function, and location. For example, module 718 of type X may be in slot 712 of chassis 710. Additionally, module 718 may have a separate serial number being used for other purposes. The separate serial number may be electronically readable by the management system 705. Further, chassis 710 may have user-defined chassis identification, such as “chassis 710,” and the module identification, such as “module 718.” Such user-defined identifications may be stored in the management system database 765.

In case module 718 fails, or needs to be replaced for other reasons, module 721 of type X may be inserted to replace module 718. According to one embodiment, the management system 705 may know how to manage module 721 as type X without having to be reconfigured for some to the reasons discussed above. Further, the module 718 may continue to be known by the user-defined module identification, module 718, and the user-defined chassis identification, chassis 710, may also be kept, and used with module 721.

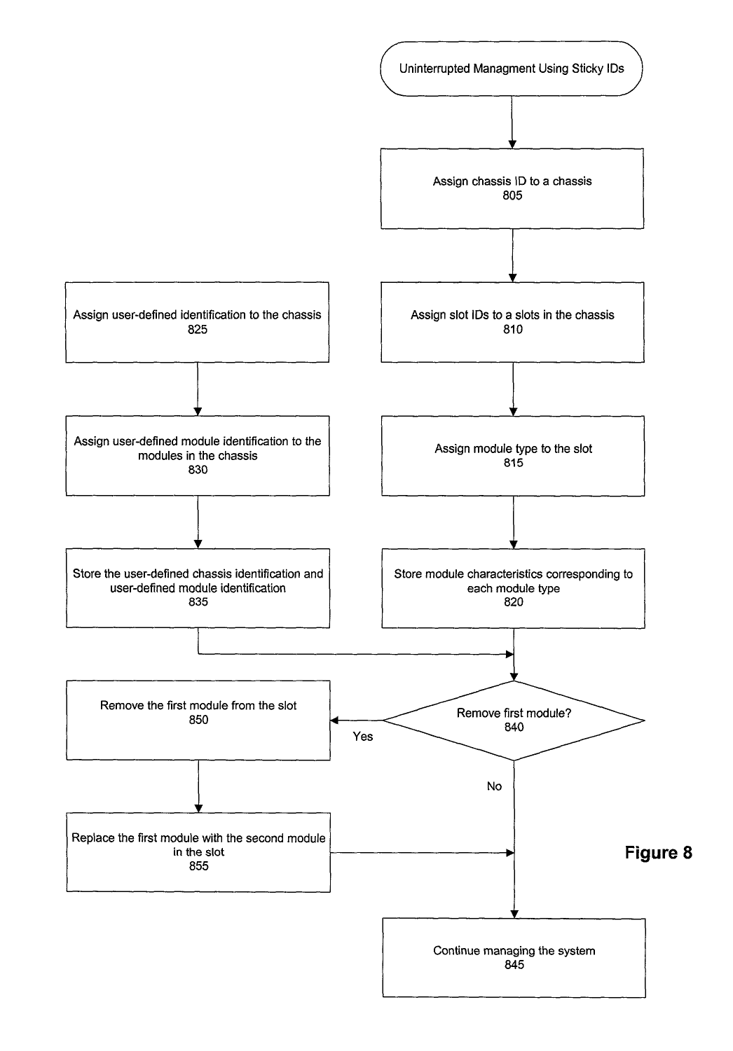

FIG. 8 is a flow diagram conceptually illustrating the process of uninterrupted management using sticky IDs, according to one embodiment of the present invention. First, the management system may assign a chassis ID number to a chassis in processing block 805. The management system may then assign a slot ID number to a slot in the chassis in processing block 810. The slot ID number may be assigned to the slot according to its location in the chassis. The management system may then assign module type to the slot based on its chassis identification and slot identification in processing block 815. The module characteristics corresponding to each module type may be stored in the memory database on one or more servers that were replicated in processing block 820.

Additionally, according to one embodiment, a user may assign user-defined chassis identification to the chassis in processing block 825. The user may also assign user-defined module identification to the modules in the chassis in processing block 830. The user-defined chassis and module identifications may also be stored in the memory database on one or more servers that were replicated in processing block 835.

According to one embodiment, at decision block 840, the management system determines whether a first module may need to be serviced or replaced for failure or other reasons. If the first module is functioning properly, the management system may continue to manage the first module in processing block 845. However, if the first module is to be removed for any failure, the failure may be reported to the management system in processing block 850. The first module may be removed from the slot in the chassis in processing block 855. A second module is then coupled to the slot in the chassis, replacing the first module in processing block 860. The management system, in processing block 845, may then continue to manage the second module according to the module characteristics corresponding to the module type of the slot as indicated by chassis identification and slot identification relating to the slot. Hence, the management system continues to manage the second module without stopping or updating for the purposes of reconfiguration.

What is claimed is:

1. A method comprising:
electing a first server as active manager server, wherein the first server resides in a chassis; and
electing a second server as the active manager server to replace the first server as the active manager server when the first server is to be replaced, wherein the second server resides in the chassis.

2. The method of claim 1, wherein the election is performed based on a predetermined criteria, wherein the predetermined criteria comprises electing a server with the lowest IP address as the active manager server.

3. The method of claim 1, further comprising:
extracting health metrics and performance metrics, wherein the health metrics and performance metrics are dynamic;
replicating the health metrics and performance metrics, wherein the replicating the health metrics and performance metrics is performed periodically; and
dynamically updating a database populated with the health metrics and performance metrics.

4. The method of claim 3, wherein the health metrics are server-based.

5. The method of claim 3, wherein the health metrics comprise tracking power levels and temperature levels based on predetermined thresholds.

6. The method of claim 3, wherein the performance metrics comprise operating system-based metrics, kernel-based metrics, and server-based metrics.

7. The method of claim 3, wherein the performance metrics comprise tracking CPU utilization and memory utilization based on the predetermined thresholds.

8. The method of claim 3, further comprises an alert mechanism to alert whenever the health metrics or the performance metrics violate the predetermined thresholds.

9. The method of claim 3, further comprising replicating identification information, wherein the identification information is static.

10. A high-availability management system comprising:
a chassis comprising a plurality of slots;
a plurality of server modules coupled with the plurality of slots, wherein a first server module of the plurality of server modules is elected an active manager server.

11. The high-availability management system of claim 10, further comprising a database coupled to the chassis for storing information regarding chassis identification, slot identification, and server module type.

12. The high-availability management system of claim 10, wherein the first server module of the plurality of server modules is elected the active manager server based on a predetermined criteria.

13. The high-availability management system of claim 10, wherein a second server module of the plurality of server modules is elected the active manager server, based on the predetermined criteria, to replace the first server module as the active manager server when the first server module is to be replaced.

14. The high-availability management system of claim 10, wherein the election of the first server module as the active manager server is performed by middleware, wherein the middleware is a software.

15. The high-availability management system of claim 13, wherein the election of the second server module as the active manager server is performed by the middleware, wherein the middleware is a software.

16. The high-availability management system of claim 10, wherein the first server module is elected from a group comprising servers, telephone line cards, and power substations.

17. A method of uninterrupted management using sticky identification comprising:
assigning a chassis identification to a chassis coupled to a computer, wherein the chassis comprises a slot;
assigning a slot identification to the slot based on the slot's location in the chassis; and
assigning a server module type to the slot based on the chassis identification and the slot identification, wherein the server module type indicates server module characteristics.

18. The method of uninterrupted management using sticky identification of claim 17, further comprising retaining the server module characteristics corresponding to the server module type.

19. The method of uninterrupted management using sticky identification of claim 17, further comprising:
removing a first server module from the slot;
coupling a second server module to the slot; and
managing the second server module based on the server module characteristics corresponding to the server module type, wherein the managing the second server module is performed without updating a network management system.

20. The method of uninterrupted management using sticky identification of claim 17, further comprising:
assigning a user-defined chassis identification;
assigning a user-defined slot identification;
assigning a user-defined module identification; and
retaining the user-defined chassis identification and the user-defined slot identification and the user-defined module identification.

21. A machine-readable medium having stored thereon data representing sequences of instructions, the sequences of instructions which, when executed by a processor, cause the processor to:
elect a first server as active manager server, wherein the first server resides in a chassis; and
elect a second server as the active manager server to replace the first server as the active manager server when the first server is to be replaced, wherein the second server resides in the chassis.

22. The machine-readable of claim 21, wherein the election is performed based on a predetermined criteria, wherein the predetermined criteria comprises electing a server with the lowest IP address as the active manager server.

23. A machine-readable medium of claim 21, wherein the sequences of instructions which, when executed by a processor, further cause the processor to:
extract health metrics and performance metrics, wherein the health metrics and performance metrics are dynamic;
replicate the health metrics and performance metrics, wherein the replicating the health metrics and performance metrics is performed periodically; and
dynamically update a database populated with the health metrics and performance metrics.

24. A machine-readable medium having stored thereon data representing sequences of instructions, the sequences of instructions which, when executed by a processor, cause the processor to:
assign a chassis identification to a chassis coupled to a computer, wherein the chassis comprises a slot;
assign a slot identification to the slot based on the slot's location in the chassis; and
assign a server module type to the slot based on the chassis identification and the slot identification, wherein the server module type indicates server module characteristics.

25. The machine-readable medium of claim 24, wherein the sequences of instructions which, when executed by a processor, further cause the processor to retain the server module characteristics corresponding to the server module type.

26. The machine-readable medium of claim 24, wherein the sequences of instructions which, when executed by a processor, further cause the processor to:
remove a first server module from the slot;
couple a second server module to the slot; and
manage the second server module based on the server module characteristics corresponding to the server module type, wherein the managing the second server module is performed without updating a network management system.
